(19) United States
(12) Patent Application Publication
(10) Pub. No.: US 2009/0081544 A1
(43) Pub. Date: Mar. 26, 2009

(54) THIN BATTERY WITH LONGER LIFE TIME

(76) Inventors: Xia-Chang Zhang, Espoo (FI); Anja Talo, Espoo (FI); Ning Hongyang, Espoo (FI)

Correspondence Address: FASTH LAW OFFICES (ROLF FASTH), 26 PINECREST PLAZA, SUITE 2, SOUTHERN PINES, NC, 28387-4301, US

(21) Appl. No.: 12/236,350

(22) Filed: Sep. 23, 2008

(30) Foreign Application Priority Data
Sep. 24, 2007 (FI) 20070724

(51) Int. Cl. H01M 6/04

(52) U.S. Cl. 429/199; 429/188; 429/231.8; 977/742; 977/752

(57) ABSTRACT

The thin battery has an anode material and a cathode material applied as pastes on one or more separator paper layers there between. The battery also has an aqueous electrolyte solution, binders and additives. The cathode paste furthermore has conductive material at least partly of carbon nanotubes. The thin battery has an anode material and a cathode material applied as pastes on one or more separator paper layers there between. The battery also has an aqueous electrolyte solution, binders and additives. The cathode paste furthermore has a conductive material at least partly of carbon nanotubes. The conductive material can additionally have one or more other allotropes of carbon, such as carbon powder, e.g. graphite powder.

### PRIOR APPLICATION

This US patent application claims priority from Finnish patent application no. F120070724, filed 24 Sep. 2007.

### TECHNICAL FIELD

The invention is concerned with a thin battery comprising an anode material and a cathode material applied as pastes on one or more separator paper layers there between, and electrolyte. The cathode paste furthermore comprises conductive material.

### BACKGROUND OF THE INVENTION

The basic components of a battery are the electrodes with terminals to connect to an external circuit, a separator to keep the electrodes apart and prevent them from shorting, the electrolyte which carries the charged ions resulting from the chemical reactions taking place at the electrodes and a cover to contain the active chemicals and hold the electrodes in place.

The chemical reactions made use of in batteries involve oxidation and reduction reactions (redox reactions). There are two broad classes of batteries, i.e. liquid state batteries (sc. “wet” batteries), in which the electrolyte is liquid or wet and solid state batteries (sc. “dry batteries”), in which the electrolyte is in a solid state. All batteries utilize similar procedures to create electricity; however, variations in materials and construction have produced different types of batteries. Even traditional batteries using Zn/MnO₂ as electrodes are often called dry batteries even if they are not really dry as they require a water solution of electrolyte.

Batteries are often classified by the type of electrolyte used in their construction. There are three common classifications; acid, mildly acid, and alkaline. Different examples of electrolytes are acids, such as sulfuric acid, salts, such as ammonium chloride and zinc chloride, and alkalis, such as sodium hydroxide or potassium hydroxide. The electrolyte solution can e.g. contain ZnCl₂ as a main ingredient as well as additive(s) as other ingredient(s), such as for example binder(s) in the Zinc/manganese dioxide battery. The additive(s) in the electrolyte solution comprises binder(s) in order to bind the electrode material particles to the electrode paste. The binder is e.g. polyvinyl alcohol (PVA).

In addition to acid, mildly acid, and alkaline electrolytes, the electrolyte might be an organic solution. For example batteries of Li-type are not suitably working in an acidic or alkaline environment. They are primarily working in solid or organic ionic liquid environments.

Thin film batteries, which term in this text is to be understood as “layered-structured batteries” in any shape or size, and flexible batteries can be made by printing on to paper, plastics, or other kind of thin foil.

Because of their relatively small thickness, the energy storage and current carrying capacity of thin film batteries is low, these properties being, however, dependent on their area as well and can be made sufficient for desired applications. They have unique properties which distinguish them from conventional batteries, and in fact the capacity is still enough for a lot of applications. Thin film batteries have e.g. a wide range of uses as power sources for consumer products and for micro-sized applications. Thin film batteries are flexible and also suitable for powering smart cards and Radio Frequency IDentification (RFID) tags.

The anode material in a battery may be e.g. Cu, Pb, Ni, Fe, Cr, Zn, Al, Mg or Li, while the cathode may be e.g. of Ferrate, Iron oxide, Cuprous oxide, Cupric oxide, Cobaltic oxide, Manganese dioxide, Lead dioxide, Silver oxide, Nickel oxyhydroxide, Nickel dioxide, Silver peroxide, Permanganate, or Bromate. E.g. a carbon/zinc cell “dry” battery uses a zinc anode, a manganese dioxide cathode, and an electrolyte of ammonium chloride and/or zinc chloride dissolved in water.

The electrodes are formed of the anode and the cathode. The anode material can in thin film batteries e.g. consist of a paste containing an anode active material and electrolyte solution with additives and the cathode material can consist of a paste containing a cathode active material and electrolyte solution with additives. The application method used to apply the cathode paste and the anode paste is e.g coating or printing.

Conductive material is added to the anode and cathode pastes. The conductive material can be carbon powder, such as graphite powder, soot, or carbon black or combinations thereof in an amount of ca 1-5% in the anode paste and in an amount of 5-20% in the cathode paste (because MnO₂ is not conductive enough).

The electrodes are connected to a collector material and the whole product is covered in an envelope. The envelope cover can be of e.g. polypropylene, polyethylene, polyester or other known cover materials. The collector material is formed to have terminals outside the layers to be connected to an external circuit. The collector material can be conductive carbon ink, carbon film or other material, which is chemically inert but conductive enough for the purpose.

The earlier application FI 20070584 of the applicant is mentioned as prior art.

High capacity cells require large volumes of electrolyte that must be accommodated between the electrodes. The more electrolyte and electrode material there is in the cell, the greater is the capacity of the cell. Thus, a small cell has less capacity than a larger cell, given the same chemistry, though they develop the same open-circuit voltage.

However, if the cell is too wet, e.g. it has too much electrolyte solution in the cell, it will have fast self discharge rate, which eventually reduces the life time of the cell. The cover should therefore have a low permeability for water vapour in order to prevent leakage of electrolyte. Leakage of electrolyte drastically shortens the lifetime of the battery. In many batteries, a certain moisture level in the cell is a must request for a battery to have a longer shelf life time.

A layered structure “thin” battery should thus have a case with a low permeability for water vapour and a high permeability to gases formed inside the battery to avoid shortening of the lifetime. Of this reason metal foils with a ventilation channel have been used as case materials in traditional batteries.

Metal foils can, however, not be used for flexible (soft) batteries, since metal is not a flexible material. Therefore, different polymer cases have been used for flexible thin batteries. To avoid evaporation of electrolyte, attempts have been made to find the best possible polymer material for the casing, but the solutions found are not satisfactory.

Carbon nanotubes (CNTs) are allotropes of carbon forming molecular-scale tubes of graphitic carbon with outstanding properties. A single wall carbon nanotube is a one-atom thick graphene sheet of graphite (called graphene) rolled up into a seamless cylinder with a diameter of the order of nanometers. This results in a nanostructure where the length-to-diameter ratio exceeds 10,000. Such cylindrical carbon molecules have novel properties, optics and other fields of materials science. They exhibit extraordinary strength and unique electrical properties and are efficient conductors of heat. They are among the stiffest and strongest fibres known, and have remarkable electronic properties and many other unique characteristics. For these reasons they have attracted huge academic and industrial interest, with thousands of papers on nanotubes being published every year. Commercial applications have, however, been rather slow to develop, however, primarily because of the high production costs of the best quality nanotubes.

There are two main types of nanotubes: single-walled nanotubes (SWNTs) and multi-walled nanotubes (MWNTs). Multi-walled nanotubes (MWNT) consist of multiple layers of graphite rolled in on themselves to form a tube shape.

The carbon nanotubes' tiny tubular structures composed of a single layer of carbon atoms could increase the capacity of batteries, according to new research. Findings published in the current issue of Physical Review Letters suggest that the diminutive tubes can hold twice as much energy as graphite, the form of carbon currently used as an electrode in many rechargeable lithium batteries. The reduction and oxidation reactions that occur at the electrodes of batteries produce a flow of electrons that generate and store energy. Subsequent tests of their energy-holding potential, conducted using electrochemistry and nuclear magnetic resonance spectroscopy, revealed an electrical storage capacity approximately double that of graphite. In explanation, the scientists note that the tubes' open ends facilitated the diffusion of lithium atoms into their interiors.

In lithium type batteries, carbon tubes have been mentioned as a new alternative in e.g. the following publications.

KR patent application 20040026207 presents such a battery solution for a lithium-sulfur battery. The cathode active material for the lithium-sulfur battery comprises complex agglomerate with a sulfur-conductive material comprising a sulfur particle on the surface where a conductive material particle is attached. The conductive material is selected from the group consisting of carbon black, graphite, carbon fiber, a carbon nanotube, activated carbon, carbon produced by heating coke or pitch, metal powder, a metal compound, or a mixture thereof.

Another such battery solution is presented in KR patent application 20040092140. A micro battery with a carbon nanotube is provided to inhibit the degradation phenomenon and to increase service life and stability of the battery significantly. The micro battery includes a cathode, an anode and an electrolyte, wherein the anode comprises a carbon nanotube formed on an anode current by deposition process such as chemical vapor deposition (CVD). Particularly, the anode current collector is formed by putting metal on a substrate, applying a catalytic metal such as nickel to grow the carbon nanotube and then, optionally performing plasma treatment or catalyst cleaning treatment. In the electrolyte, a solid polymer is employed. The cathode comprises lithium metal oxide.

Still one reference is the Japanese publication JP7014582. It is concerned with a nonaqueous electrolytic battery whose internal resistance is reduced. Its battery electrode contains as positive electrode active material a manganese dioxide or lithium transition metal oxide, and as a positive electrode electro-conductivity giving agent, a carbonaceous material containing carbon nanotube or carbonaceous material containing carbon nanotube including metal ions is added.

The object for this invention is an improved thin and flexible wet battery with a longer lifetime and which solves the above mentioned prior art problem of electrolyte evaporation.

### SUMMARY OF THE INVENTION

The thin battery of the invention comprises an anode material and a cathode material applied as pastes on one or more separator paper layers there between. The battery also comprises an aqueous electrolyte solution, binders and additives. The cathode paste furthermore comprises conductive material at least partly of carbon nanotubes.

The conductive material can additionally comprise one or more other allotropes of carbon, such as carbon powder, e.g. graphite powder.

In the invention it was found that when carbon nanotubes are used in wet batteries using aqueous electrolyte solution, a surprising effect occurs. As was stated in the background section, leakage of electrolyte drastically shortens the lifetime of the battery, especially in normal acidic and alkaline wet batteries. As carbon nanotube materials are very expensive materials for the time being, the use of them just because of their conductivity purpose would not be motivated as other materials, like ordinary graphite powder, are equally useful. This effect of the nanotubes, making the batteries more long lasting, is expected to justify and motivate the use of carbon nanotubes in alkaline and acidic thin batteries using aqueous electrolyte solutions.

When carbon nanotubes are introduced in an acidic or alkaline wet battery according to the invention, battery lifetime increases considerably. Besides other acknowledged properties of the nanotubes, i.e. its low density (for a solid 1.3 to 1.4 g/cm³ normal graphite has a density over 2.0 g/cm³) and its metallic and high conductivity for Multi Wall NanoTubes (MWNT), it has a high capacity for holding more electrolyte solution. Tests show that this is a consequence of the presence of the nanotubes. The reason for the property to hold more electrolyte solution is that the tubes absorb moisture inside and the electrolyte will be released only when needed.

Both low density and high conductivity make the thin and flexible battery working properly without increasing the weight and the internal resistance of the cell. The tubular structure of carbon nanotubes has a property to hold more electrolyte solution, which gives our battery a longer life time comparing to using carbon powder alone as conductive particles in the cathode paste. The total amount of carbon (carbon powder +carbon nanotubes) will remain the same as in previous solutions, i.e. a part of the carbon powder is substituted by the nanotubes.

It is not only most important to have conductive material in the cathode paste but also the anode material usually comprises some conductive material. Analogously, it is more important to replace a part of the carbon graphite powder with carbon nanotubes in the cathode paste, but also the conductive material in the anode paste can, if desired, be replaced with carbon nanotubes.

Tests have shown that the carbon nanotubes work extremely well at least in thin batteries wherein the active cathode material preferably is manganese dioxide (MnO₂), the active anode material is Zinc (Zn), and the electrolyte is Zinc Chloride (ZnCl₂). The electrolyte solution contains Poly Vinyl Alcohol (PVA) and other additives as binder in a known manner.

The carbon nanotubes tested had an inner diameter of 5-15 nm and a tube length of 10-20 μm. It is, however, clear for one skilled in the art that the inventive effect is not restricted to just these tested dimensions. The amount of carbon nanotubes of the conductive material can suitably be e.g. 5-100%, preferably 20-40%. The tested carbon nanotubes are of multi-wall type.

In the following the inventive effect will be shown by means of some tests described in the following examples.

### DETAILED DESCRIPTION

The inventive effect of the present invention was tested by means of batteries of the following composition

Battery construction used in the test:

Electrolyte: ZnCl₂

Cathode active material: MnO₂

Anode active material: Zn

Separator: paper

Sealing material: polymer films

Collector: conductive ink

Binder: PVA and additives

Conductive material: graphite powder and different amounts of carbon nanotubes

### EXAMPLES 1-4

Test batteries were prepared by coating anode and cathode pastes on separator papers. The anode paste containing active anode material and an aqueous electrolyte solution comprising the ZnCl₂ electrolyte, PVA binder and other additives were coated on a separator paper. The cathode paste containing similar electrolyte solution was coated on another separator paper. The layers coated with the anode and cathode pastes were then laminated together with the cathode and anode layers outside and the electrolyte there between. Thereafter anode collector material was added on the anode side of the product and cathode collector material on the cathode side of the product. Last, a sealing material was added on both sides to form an envelope around the product. The sealing material used was a polymer film.

Four different tests were made for batteries, wherein a part of the carbon powder material was replaced by carbon nanotube material. The first one being the prior art test contained only carbon powder as the conductive material in the cathode paste. In the three other tests 20%, 40% and 60% respectively of the carbon powder in the cathode paste was replaced by carbon nanotube material.

The carbon nanotube material used was of multi wall carbon nanotube type of the commercial Timesnano material of product number M1208, purity >95%, Inner diameter 5-15 nm, Tube length 10-20 μm, Specific Surface Area (SSA) >40 m²/g

The carbon powder used was graphite one from Riedel-de-Haen, product no 15553, particle size (96% of the particles) <0.01 mm.

The test results are presented in the following table

| | | | | | | Capacity |
|---|---|---|---|---|---|---|
| | | Carbon | Percentage | | | (mAh) |
| | Carbon | nano | of | Electrolyte | Capacity | (much |
| Test | powder | tubes | carbon | solution | (mAh) | longer |
| no | (g) | (g) | nanotubes | (g) | (3 months) | time) |
| 1 | 1.5 | 0 | 0 | 8.4 | 62 | 9 |
| 2 | 1.2 | 0.3 | 20% | 9.5 | 69 | 21 |
| 3 | 0.9 | 0.6 | 40% | 11.8 | 73 | 31 |
| 4 | 0.6 | 0.9 | 60% | 15.1 | 75 | 31 |

From the results it can clearly be seen that the battery with carbon nanotubes keeps higher capacity for a longer time. The shelf life time of the battery increases with the increase of percentage of the carbon nanotubes. The results also illustrate that the battery with more carbon nanotubes holds more electrolyte solution, which is a clear indication of that the nanotubes absorb electrolyte solution but still keeps the battery rather “dry”. The rather “dry” battery makes the self discharge lower.

According to the table, it is optimal to use 40% of nanotubes of the total carbon amount; thereafter the difference is not so significant anymore.

The capacity is larger by about 20% from the cells with more than 40% carbon nanotube than the cells without carbon nanotube after 3 month storage time. It is also clear from the results that the difference becomes much larger after much longer storage time.

While the present invention has been described in accordance with preferred compositions and embodiments, it is to be understood that certain substitutions and alterations may be made thereto without departing from the spirit and scope of the following claims.

We claim:

1. A thin battery comprising:
an anode material and a cathode material applied as pastes on one or more separator paper layers there between, and
an aqueous electrolyte solution, binders and additives,
the cathode material paste furthermore comprising a conductive material, and
the conductive material comprising carbon nanotubes.

2. The thin battery of claim 1, wherein the thin battery is an acidic or alkaline thin battery.

3. The thin battery of claim 1 wherein the conductive material additionally comprises one or more allotropes of carbon.

4. The thin battery of claim 3, wherein the conductive material additionally comprises carbon graphite powder.

5. The thin battery of claim 1 wherein the anode material comprises a conductive material.

6. The thin battery of claim 1 wherein the cathode material comprises MnO₂, the anode material comprises Zn, and the aqueous electrolyte solution comprises ZnCl₂.

7. The thin battery of claim 1 wherein the electrolyte solution contains Poly Vinyl Alcohol (PVA) and a binder.

8. The thin battery of claim 1 wherein an inner diameter of the carbon nanotubes is 1-50 nm.

9. The thin battery of claim 1 wherein an amount of carbon nanotubes of the conductive material is 5-100%.

10. The thin battery of the carbon nanotubes are of multi-wall type.
